(19) United States
(12) Patent Application Publication
(10) Pub. No.: US 2021/0295746 A1
(43) Pub. Date: Sep. 23, 2021

(54) SIGNAGE SYSTEM

(71) Applicant: Toyota Jidosha Kabushiki Kaisha, Toyota-shi Aichi-ken (JP)

(72) Inventors: Masahiro Nishiyama, Toyota-shi (JP); Kenji Tsukagishi, Toyota-shi (JP); Takahisa Kaneko, Toyota-shi (JP); Erina Kigoshi, Minato-ku (JP); Aiko Miyamoto, Toyota-shi (JP)

(21) Appl. No.: 17/199,897

(22) Filed: Mar. 12, 2021

(30) Foreign Application Priority Data
Mar. 17, 2020 (JP) 2020-046123

(51) Int. Cl. G09F 9/00; G09F 21/04

(52) U.S. Cl. CPC G09F 9/00; G09F 21/048

(57) ABSTRACT

A signage system includes at least one vehicle, a display device configured to display an image on one or more display areas viewable from outside of the at least one vehicle, and a signage controller which is configured to function as an information collecting unit for communicating with a viewer vehicle which is another vehicle located at a position facing the display area, to collect information of at least one of the viewer vehicle and an occupant of the viewer vehicle as surrounding information, an image selecting unit for selecting an image to be displayed on the display area based on the surrounding information, and a display controlling unit for causing the display area to display the selected image.

### CROSS REFERENCE TO RELATED APPLICATION

This application claims priority to Japanese Patent Application No. 2020-046123 filed on Mar. 17, 2020, which is incorporated herein by reference in its entirety including the specification, claims, drawings, and abstract.

### TECHNICAL FIELD

The present disclosure discloses a signage system configured to display an image on a display which is mounted on a vehicle and viewable from outside of the vehicle.

### BACKGROUND

There have been conventionally known techniques for mounting a display on an outer surface of a vehicle and displaying images on the display in order to utilize the vehicle as movable digital signage. For example, JP 2019-117215 A discloses a technique for mounting a display on an exterior surface of a vehicle and displaying a commercial advertising image on the display. Further, J P 2010-237411A discloses a technique for displaying, on a display section disposed on a rear part of a vehicle, an advertising image corresponding to an identification result obtained by capturing an image of a license plate of another vehicle following the vehicle, and identifying a registration location and other information of the other vehicle based on the captured license plate.

However, in JP 2019-117215 A, how an image to be displayed is selected is unknown. On the other hand, in JP 2010-237411 A, although the commercial image is selected based on the license plate, information that can be acquired from the license plate is limited. Therefore, in the conventional techniques, it has not been possible that the vehicle always displays an advertising image that matches an occupant of another vehicle located near the vehicle.

In recent years, information technology associated with vehicles has drastically advanced, and connected vehicles capable of communicating not only with a specific management center but also with various “things” have been suggested. Such connected vehicles perform, for example, vehicle-to-vehicle (V2V) communication which is communication between vehicles, vehicle-to-infrastructure (V2I) communication which is communication between a vehicle and infrastructure equipment disposed on a road, vehicle-to-pedestrian (V2P) communication which is communication between a vehicle and a terminal device carried by a pedestrian, and the like. Conventionally, effective utilization of information obtained through such connected technology has not been studied sufficiently.

Under these circumstances, the present disclosure discloses a signage system capable of using information acquired through connected technology to thereby enhance effectiveness of posting advertisement and attracting attention.

### SUMMARY

In an aspect of the present disclosure, a signage system includes at least one vehicle, a display device mounted on the at least one vehicle and configured to display an image on one or more display areas viewable from outside of the at least one vehicle, and a signage controller configured to function as an information collecting unit configured to communicate with a viewer vehicle being another vehicle located at a position facing the display area, in order to collect information about at least one of the viewer vehicle and an occupant of the viewer vehicle as surrounding information, function as an image selecting unit configured to select an image which is displayed on the display area, and function as a display controlling unit configured to cause the display area to display the selected image.

When configured as described above, because the signage system is able to select an image which is appropriately fitted to the occupant of the viewer vehicle, effects of posting advertisement and attracting attention can be enhanced.

In the above-described configuration, the one or more display areas may include at least a display area which is arranged at a position viewable from behind the at least one vehicle.

In general, as a vehicle following another vehicle is apt to maintain visibility of the other vehicle for a longer length of time than a vehicle driving alongside the other vehicle, the effectiveness of posting advertisement and attracting attention can be further enhanced when the image is displayed on the display area which is arranged at the position viewable from the following vehicle.

In an aspect, the signage controller is configured to select the image based on attribute information of at least one of the viewer vehicle and the occupant of the viewer vehicle, the attribute information being found from the surrounding information, while disabling use of action histories of the viewer vehicle and the occupant thereof for selecting the image.

In contrast to Internet advertisement, the display area of the signage system can be easily viewed by a person other than the occupant of the viewer vehicle. In this case, if an image associated with the action history of the viewer vehicle or the occupant of the viewer vehicle is displayed, there is a danger that privacy of the occupant of the viewer vehicle will not be protected appropriately. On the other hand, the privacy of the occupant can be appropriately protected by disabling, as described above, the use of the action histories for selecting the image.

In an aspect, the signage controller may modify the image which is displayed on the display area, based on at least one of a relative positional relationship and a relative velocity relationship between the vehicle and the viewer vehicle.

When the size of a figure, a character font, or other features contained in the image is appropriately changed or an amount of information contained in the image is appropriately increased or decreased based on at least one of the relative positional relationship and the relative velocity relationship, the image can be more easily recognized from the viewer vehicle, which can help further improve the effects of posting advertisement and attracting attention.

In an aspect, the viewer vehicle may include a user interface configured to receive an input of an operation instruction directed to the image displayed on the display area of the vehicle, and the signage controller may perform processing in accordance with the operation instruction.

When the signage controller is configured to receive an action of the occupant of the viewer vehicle, utility of posting advertisement or attracting attention can be increased.

In an aspect, the signage controller may include a center controller which is installed in a management center and a vehicle controller which is mounted on the vehicle and configured to communicate with the center controller, and the vehicle controller may be configured to communicate with the viewer vehicle in order to acquire the surrounding information, and transmit the acquired surrounding information to the center controller.

When the vehicle controller is configured to communicate with the viewer vehicle in order to acquire the surrounding information, a process to acquire the surrounding information performed by the center controller can be simplified as compared to a case where the center controller identifies, by itself, the viewer vehicle and communicates with the identified viewer vehicle to acquire surrounding information from the viewer vehicle.

According to the signage system disclosed herein, information acquired by the connected technology can be utilized to enhance the effects of posting advertisement and attracting attention.

### BRIEF DESCRIPTION OF DRAWINGS

Embodiments of the present disclosure will be described based on the following figures, wherein:

FIG. 1 is a block diagram showing a functional configuration of a signage system;

FIG. 2 is a block diagram showing a physical configuration of the signage system;

FIG. 3 is a perspective view of a vehicle;

FIG. 4 is a diagram showing a flow of process steps performed in the signage system;

FIG. 5 is a diagram showing a correlation between an image displayed on a display area and a relative positional relationship between a displayer vehicle and a viewer vehicle; and

FIG. 6 is an image showing an image representation displayed on a display area and a user interface (U/I).

### DESCRIPTION OF EMBODIMENTS

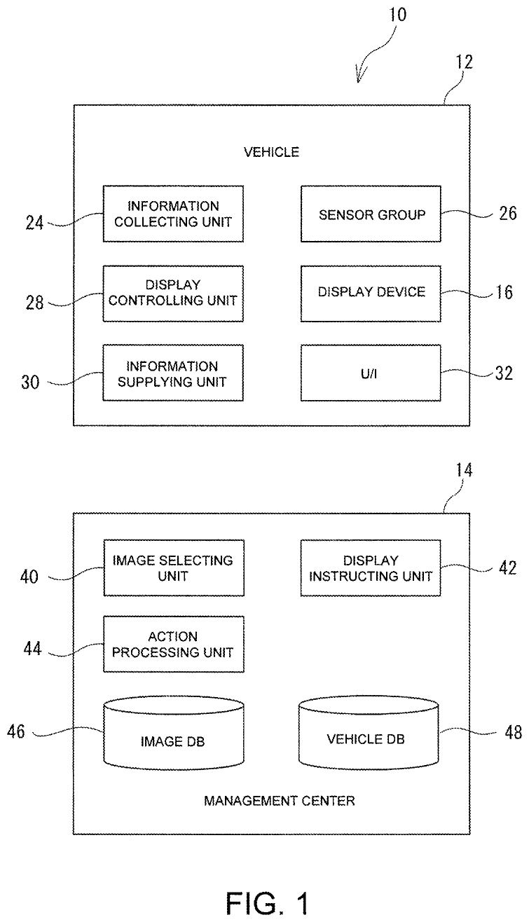

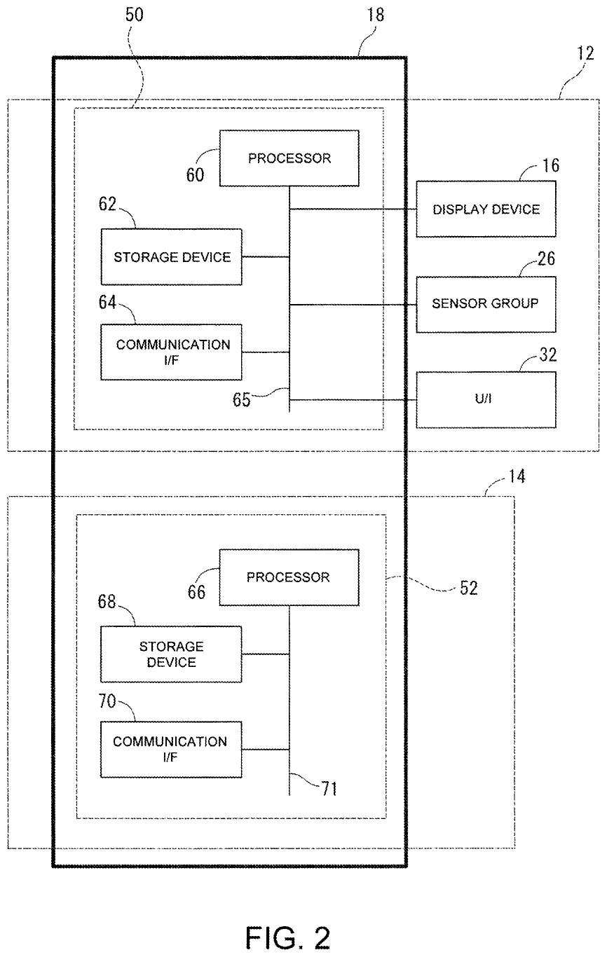

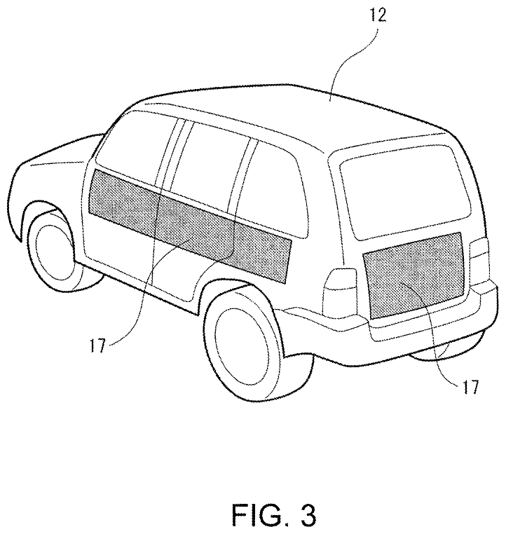

Hereinafter, a configuration of a signage system 10 will be described with reference to the drawings. FIG. 1 is a functional block diagram of the signage system 10, and FIG. 2 is a physical block diagram of the signage system 10. FIG. 3 is a perspective view of a vehicle 12 used in the signage system 10.

The signage system 10 is a system which causes a display device 16 disposed on the vehicle 12 to display an image on a display area 17 (such as, for example, the display area 17 disposed on a rear surface of the vehicle 12 shown in FIG. 3) which is viewable from outside of the vehicle 12, to thereby utilize the vehicle 12 as movable digital signage. The image displayed on the display area 17 of a one vehicle 12 is viewed by an occupant of another vehicle present near the one vehicle 12. In the description below, the vehicle 12 which displays the image is referred to as a “displayer vehicle”, while a vehicle on which the occupant viewing the image is riding is referred to as a “viewer vehicle”. The one vehicle 12 can simultaneously function as the displayer vehicle and the viewer vehicle. For example, in a situation where the one vehicle 12 is displaying on its rear surface an image for another vehicle following the one vehicle 12, if a further vehicle driving ahead of the one vehicle 12 displays an image on its rear surface, the one vehicle 12 functions as the displayer vehicle and also functions as the viewer vehicle at the same time.

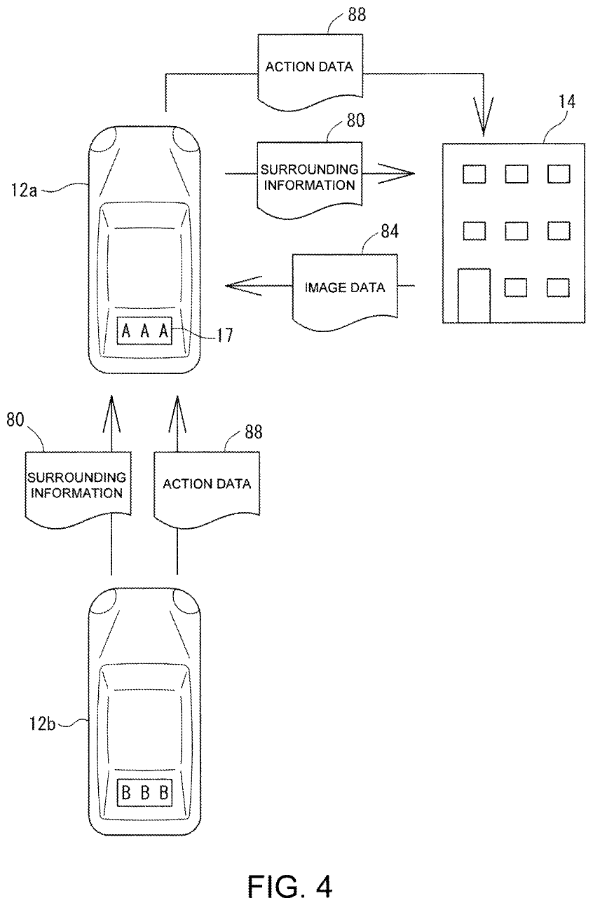

Next, referring to FIG. 1, components of the vehicle 12 will be described. An information collecting unit 24, a sensor group 26, a display controlling unit 28, and the display device 16 are utilized when the vehicle 12 functions as the displayer vehicle. The information collecting unit 24 is configured to communicate with another vehicle present near the vehicle 12; i.e. a vehicle functioning as the viewer vehicle in order to collect information of the viewer vehicle or an occupant of the viewer vehicle as surrounding information 80 (see FIG. 4). The surrounding information 80 includes, at least, identification information of the viewer vehicle or the occupant thereof. The information collecting unit 24 transmits the collected surrounding information 80 to a management center 14.

In addition, the information collecting unit 24 also collects action data 88 (see FIG. 4) through communication with the viewer vehicle. The action data 88 is data representing instructions input by the occupant of the viewer vehicle through operation of a user interface (U/I) 32 installed in the viewer vehicle, which will be described below. The information collecting unit 24 also transmits the collected action data 88 to the management center 14.

The sensor group 26 is composed of one or more sensors mounted on the vehicle 12. The sensor group 26 may include, for example, a position sensor (such as, for example, a GPS sensor) which detects a location of the vehicle 12. The detection result from the position sensor may be transmitted to the management center 14 together with the surrounding information 80. Further, the sensor group 26 may include a surrounding environment sensor which detects a surrounding environment around the vehicle 12. The surrounding environment sensor may include, for example, a camera, a Lidar instrument, a millimetric waver radar, a sonar, a magnetic sensor, etc. The vehicle 12 acquires, based on the detection result from the surrounding environmental sensor, at least one of a relative position and a relative velocity of the vehicle 12 with respect to the viewer vehicle. The acquired relative position and relative velocity are sent to the display controlling unit 28.

The display controlling unit 28 is configured to control operation of the display device 16. Specifically, the display controlling unit 28 operates the display device 16 to display image data 84 transmitted from the management center 14. Further, the display controlling unit 28 modifies the image data 84 based on at least one of a relative positional relationship and a relative velocity relationship with the viewer vehicle, which will be described below.

The display device 16 is operated to display an image on the display area 17 which is viewable from outside of the vehicle 12 (see FIG. 3). As the display device 16, for example, a display disposed on an exterior surface of the vehicle 12 may be used. In such a case, the display functions as the display area 17. When the display device 16 is the display, the display device 16 may be attached to the exterior surface of the vehicle 12 as shown in FIG. 3, or may be attached to an inner surface of a window glass of the vehicle 12. Alternatively, the display device 16 may be composed of a transparent display which may be arranged within a window of the vehicle 12 in place of the window glass of the vehicle 12. In a case where the display arranged within the window hampers the occupant from viewing outside scenery through the window, a camera for capturing images of the outside scenery may be mounted on the vehicle 12 along with a display which is configured to display the images captured by the camera.

Further alternatively, the display device 16 may be a projector which projects the image onto a portion (such as, for example, an engine hood or a trunk hood) of the vehicle 12 or onto a road surface. In such a case, the area onto which the image is projected by the projector serves as the display area 17.

The vehicle 12 includes at least one display area 17 disposed at a location which can be viewed from behind the vehicle 12. In general, a vehicle following another vehicle tends to maintain visibility of the other vehicle for a longer length of time than a vehicle driving alongside the other vehicle. For this reason, arranging the display area 17 on the location viewable from the following vehicle can help improve an effect of posting advertisement or attracting attention. Display areas 17 may be disposed on two or more surfaces of the vehicle 12. For example, the display areas 17 may be disposed on the rear surface and a side surface of the vehicle 12 as illustrated in FIG. 3. In this case, the display area 17 on the rear surface and the display area 17 on the side surface may display the same image or may display images which differ from each other.

It should be noted that one displayer vehicle is not necessarily associated with only one viewer vehicle, and may be associated with two or more viewer vehicles. For the vehicle 12 shown in FIG. 3, for example, both the following vehicle which can view the image on the display area 17 of the rear surface and the alongside driving vehicle which can view the image on the display area 17 of the side surface function as viewer vehicles. In this case, the vehicle 12 collects the surrounding information 80 from both the following vehicle and the alongside driving vehicle and transmits the collected surrounding information 80 to the management center 14. The management center 14 transmits to the vehicle 12 image data 84 of an image which is selected based on the surrounding information 80 of the following vehicle and image data 84 of an image which is selected based on the surrounding information 80 of the alongside driving vehicle. The vehicle 12 respectively displays the images in the received image data 84 on corresponding display areas 17.

An information supplying unit 30 and the user interface 32 are utilized when the vehicle 12 functions as the viewer vehicle. The information supplying unit 30 communicates with the displayer vehicle to supply the displayer vehicle with information of at least one of the vehicle 12 itself and the occupant of the vehicle 12; i.e. the information which is the surrounding information 80 for the displayer vehicle. Further, through communication with the displayer vehicle, the information supplying unit 30 supplies the displayer vehicle with data indicative of instructions input through the user interface 32; the data being the action data 88 for the displayer vehicle.

The user interface 32 is configured to receive an operation instruction from the occupant of the vehicle 12. The user interface 32 may be of a touch type or a voice input type. In a case of the touch type, the user interface 32 includes at least either one of switches or a touch panel. On the other hand, in a case of the voice input type, the user interface 32 includes a microphone for receiving a voice command. The configuration of the user interface 32 may be fixed or changeable, including, for example, functions assigned to the switches, the number of virtual switches to be displayed on the touch panel, functions of the virtual switches, and acceptable voice commands, and other features of the user interface 32.

The thus-configured vehicle 12 is, as shown in FIG. 2, physically equipped with a vehicle controller 50 which includes a processor 60, a storage device 62, and a communication interface 64. The vehicle controller 50 and a below-described center controller 52 cooperatively constitute a signage controller 18 which collects the surrounding information 80 and causes the display device 16 to display a predetermined image based on the surrounding information 80.

The vehicle controller 50 is a computer incorporating the processor 60, the storage device 62, the communication interface 64, and a data bus 65. The term “computer” embraces a microcontroller in which a computer system is incorporated into a single integrated circuit. It should be noted that the processor 60 denotes a processor in a broad sense and includes a general-purpose processor (such as, for example, a Central Processing Unit, CPU), a special-purpose processor (such as, for example, a Graphics Processing Unit, GPU; an Application Specific Integrated Circuit, ASIC; a Field Programmable Gate Array, FPGA; and a programmable logic device).

The storage device 62 may include at least one of a semiconductor memory (such as, for example, a RAM, a ROM, and a solid state drive) and a magnetic disc (such as, for example, a hard disc drive).

The communication interface 64 allows the vehicle 12 to communicate with various devices located outside the vehicle 12. The communication interface 64 may support a plurality of types of communication protocols. Therefore, the communication interface 64 may include a communication facility capable of Internet communication through a wireless LAN, such as, for example, Wi-Fi (registered trademark), or through mobile data communication services provided by mobile phone companies, or the like. In addition, the communication interface 64 may include a communication facility (such as an antenna) for Dedicated Short Range Communication (DSRC) to communicate with other vehicles and infrastructure facilities on roads. The vehicle controller 50 exchanges various data via the communication interface 64 with the management center 14 and other vehicles. The display device 16, the sensor group 26, and the user interface 32 mounted on the vehicle 12 are connected via a data bus to the processor 60, and various signals are transmitted and received through the data bus.

Next, the management center 14 will be explained with reference to FIG. 1. The management center 14 includes an image selecting unit 40, a display instructing unit 42, an action processing unit 44, an image database 46, and a vehicle database 48. The image selecting unit 40 selects, based on the surrounding information 80 transmitted from the vehicle 12, an image which is to be displayed on the display area 17 of the vehicle 12. To select the image, the image selecting unit 40 refers to the vehicle database 48 and the image database 46.

The vehicle database 48 stores various items of information about the vehicle 12 and the occupant of the vehicle 12. Specifically, the vehicle database 48 stores attributes of the vehicle 12 and the occupant, in which the attributes of the vehicle 12 are associated with those of the occupant. The attributes of the vehicle 12 include, for example, identification information, a model name, a grade, a registered location, and a registration date of the vehicle 12; information as to whether or not the vehicle 12 is a rental car or owned by a juridical person or not; and the like. Meanwhile, the attributes of the occupant include, for example, identification information, age, gender, family members, the professional occupation, the place of residence, and the birthplace of the occupant. Such attribute information of the vehicle 12 and the occupant may be acquired through previous registration performed by the occupant using an information terminal. Alternatively, the attribute information of the vehicle 12 and the occupant may be automatically acquired or updated based on information that is obtained by a salesperson or a maintenance staff at a time when the vehicle 12 is sold or during maintenance checkups of the vehicle 12. On the other hand, when the vehicle 12 is the rental car, a user of the rental car may be registered as the occupant based on information that is acquired by a rental car company when the vehicle 12 is leased. When the vehicle 12 is not a rental car but is owned by a juridical person, the juridical person may be registered as the occupant.

In addition to the attributes of the vehicle 12 and the occupant, the vehicle database 48 may store action histories, payment information, e-mail addresses, and other information items relating to the vehicle or the occupant. The action history of the vehicle 12 may include, for example, a driven route history, destinations registered in a vehicle navigation system, stores or other facilities near which the vehicle 12 was parked over a predetermined length of time, etc. The action history of the occupant includes a search history and a shopping history of the occupant, for example. The action history of the occupant is acquired based on a history of operation of the information terminal associated with the vehicle 12, information on payment which is made by electronic payment or electronic money associated with the vehicle 12, and other information items. When other items of information, such as a particular payment method and an e-mail address, associated with the vehicle 12 or the occupant are available, those items of information are also recorded in the vehicle database 48.

The items of information recorded in the vehicle database 48 are grouped by protection levels and managed under protection level groups, the protection level being determined for each of the items to allow or prohibit reference to the item depending on a purpose of use of the item. In this example, the action histories of the vehicle 12 and the occupant are assigned a protection level which is higher than that of the attribute information. When selecting an image to be displayed on the vehicle 12, the image selecting unit 40 makes reference only to the attribute information of the vehicle 12 and the occupant, but is not allowed to make reference to the action histories assigned with the protection level higher than the attribute information. In another embodiment, a usable level of information used for selecting the image data 84 may be previously specified by the occupant of the viewer vehicle.

The image database 46 stores a large amount of image data 84 and selection conditions for the image data 84. The image data 84 is data of a great number of images to be displayed on the display area 17 of the vehicle 12. The image displayed on the display area 17 may be a static image or a moving image. The image may be a commercial or advertising image, for example. Further, the image may be an image representing, for example, evacuation information, relief information, and other information required in the event of a disaster, for example.

Each image in the image data 84 is linked to a selection condition for selecting the image. The selection condition includes at least a target condition of a corresponding image. The target condition is a condition of an intended target viewer of the corresponding image. Whether or not to match the target condition can be determined from the attribute information of the vehicle and its occupant recorded in the vehicle database 48. Therefore, the target condition includes, for example, age, gender, family members, the professional occupation, the place of residence, the birthplace, and other features of the intended targeted viewer of the image, and a model name, a grade and other properties of the vehicle. For example, a condition of “gender: male” may be specified as the target condition to the image data 84 of commercial images provided by a men's apparel maker. Further, as the target condition, a condition that the place of residence matches an address in a disaster stricken area may be specified to the image data 84 of an image that notifies locations of refuges from a disaster.

In addition, the selection condition may further include a regional condition, a temporal condition, and a priority level of the corresponding image. For example, a regional designation of “Kanto area” is specified as the regional condition to the image data 84 of images that are intended to be displayed only in the region of “Kanto area”. Here, the displayer vehicle may transmit, in addition to the surrounding information 80, information on a current position of the displayer vehicle itself to the management center 14 in order to determine whether the regional condition is satisfied. Meanwhile, a time period of “nighttime” may be specified as the temporal condition to the image data 84 of images that are intended to be displayed only at night. The priority level defines prioritization of the corresponding image data 84. The image data 84 of an image that is assigned a higher priority level is more preferentially selected. The priority level is determined, for example, by the fee paid for displaying a commercial image, the degree of urgency associated with image data 84 of an image, or the degree of public benefit contributed by image data 84 of an image. For example, the image data 84 of an image that is charged at a higher rate may be assigned a higher priority level. Meanwhile, in the event of a disaster, the image data 84 assigned a higher degree of urgency or public benefit, such as image data 84 of an image representing evacuation information, may be prioritized.

The image selecting unit 40 refers to the vehicle database 48 and the image database 46 to select the image data 84 to be displayed on the display area 17 of the displayer vehicle. Specifically, the image selecting unit 40 checks the surrounding information 80 transmitted from the displayer vehicle against the vehicle database 48 to acquire the attribute information of the viewer vehicle and the occupant thereof. Following this, the image selecting unit 40 checks the acquired attribute information against the image database 46 to select the image data 84 suitable for display. Specifically, the image selecting unit 40 selects image data 84 which has a target condition that matches the attribute of the viewer vehicle or the occupant thereof and is assigned a higher priority level. The image selecting unit 40 transmits the selected image data 84 to the display instructing unit 42. Then, the display instructing unit 42 transmits the image data 84 to the displayer vehicle.

The action processing unit 44 performs predetermined process steps in accordance with the action data 88. As described above, the action data 88 is, as described above, data representing the operation instructions which are input through the user interface 32 by the occupant of the viewer vehicle. The process steps performed in accordance with the operation instruction by the action processing unit 44 will be described below.

The above-described management center 14 is physically equipped with the center controller 52 which includes, as shown in FIG. 2, a processor 66, a storage device 68, and a communication interface 70. Then, as described above, the center controller 52 and the vehicle controller 50 cooperatively constitute the signage controller 18.

The center controller 52 is also composed of a computer which incorporates, similarly to the vehicle controller 50, the processor 66, the storage device 68, the communication interface 70, and a data bus 71. As used herein, the term “computer” embraces a microcontroller in which a computer system is incorporated into a single integrated circuit. Further, the processor 66 is a processor in a broad sense, and thus includes a general-purpose processor and a special-purpose processor.

The storage device 68 may include at least one of a semiconductor memory (such as, for example, a RAM, a ROM, and a solid state drive) and a magnetic disc (such as a hard disc drive). Further, the storage device 68 may not necessarily be located, in its entirety, on the same physical location as the processor 66 or other components, and may include a storage device located in a cloud. The communication interface 70 is a component which enables communication with various external devices located outside of the management center 14, and may include, for example, a communication facility for establishing Internet communication.

Next, a flow of process steps performed in the above-described signage system 10 is described with reference to FIG. 4. FIG. 4 is a diagram schematically showing the flow of process steps performed in the signage system 10. In the signage system 10, vehicle 12 that is located at a position facing the display area 17 of a displayer vehicle 12a functions as a viewer vehicle 12b. When the display area 17 is disposed on the rear surface of the displayer vehicle 12a, a vehicle which follows the displayer vehicle 12a is the viewer vehicle 12b.

The displayer vehicle 12a outputs a request for the surrounding information 80 to the viewer vehicle 12b. In response to the request, the viewer vehicle 12b transmits the surrounding information 80 to the displayer vehicle 12a.

The displayer vehicle 12a transmits the obtained surrounding information 80 to the management center 14. The management center 14 checks the surrounding information 80 against the vehicle database 48 to retrieve attribute information of the viewer vehicle 12b and an occupant of the viewer vehicle 12b. Then, the management center 14 checks the retrieved attribute information against the image database 46 to select the image data 84 to be displayed on the displayer vehicle 12a. It should be noted that, as described above, the action histories of the viewer vehicle 12b and the occupant thereof are not looked up to select the image data 84. This is determined in consideration of a situation in which, as distinct from Internet advertisement, the signage system 10 displays the image on the vehicle 12 which can be easily viewed by any person other than the occupant of the viewer vehicle 12b. If an image that reflects the action histories of the viewer vehicle 12b and the occupant thereof is displayed in the situation, there is a risk that personal information will be leaked, or privacy will not be protected appropriately. To circumvent the risk, the image to be displayed on the vehicle 12 is selected based on relatively sketchy information, such as the attribute information.

After the image data 84 is selected, the management center 14 transmits the selected image data 84 to the displayer vehicle 12a. The displayer vehicle 12a displays the received image data 84 on the display area 17. Here, the form of display of the image displayed on the display area 17 may be modified based on at least one of a relative position and a relative velocity of the viewer vehicle 12b with respect to the displayer vehicle 12a.

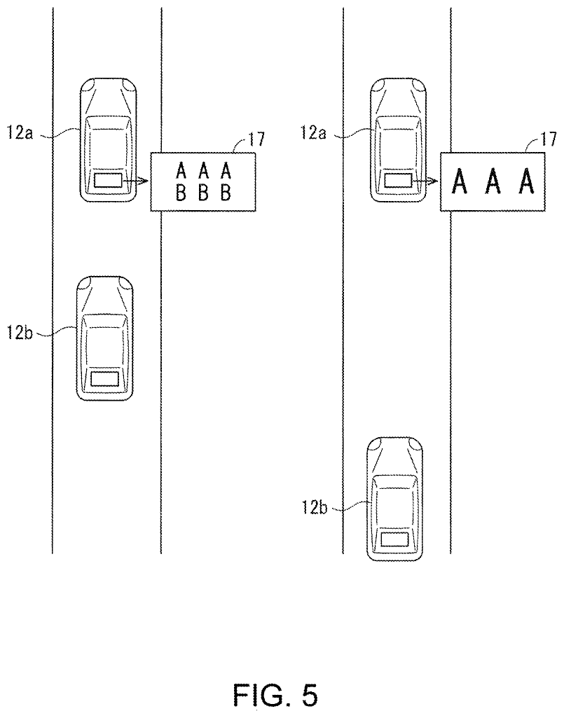

For example, as the relative position approaches the reference position, the size of at least one of a figure or text contained in the image may be decreased. That is, when a distance between the displayer vehicle 12a and the viewer vehicle 12b is small (as shown on the left side of FIG. 5), the size of a figure and of the font of text contained in the image displayed on the display area 17 may be decreased, to thereby display a greater amount of information. In this way, a greater amount of information can be supplied to the occupant of the viewer vehicle 12b.

On the other hand, when the distance between the displayer vehicle 12a and the viewer vehicle 12b is great (as shown on the right side of FIG. 5), the size of the figure and of the font of text contained in the image displayed on the display area 17 may be increased, to adjust the image in such a manner that the image can be easily viewed from a distant location. This can ensure that necessary information is reliably supplied to the occupant of the viewer vehicle 12b.

Meanwhile, as the relative velocity between the displayer vehicle 12a and the viewer vehicle 12b decreases, an amount of text information contained in the image may be increased. Specifically, when the relative velocity is low, the occupant of the viewer vehicle 12b is able to view the image on the display area 17 under a relatively stable condition, which allows the occupant to recognize an increased amount of text information contained in the image. On the other hand, when the relative velocity between the displayer vehicle 12a and the viewer vehicle 12a is high, an occupant of the viewer vehicle 12b cannot easily recognize image details such as text because the distance between themselves and the display area 17 is not constant. Therefore, under such conditions the amount of text information contained in the image may be reduced.

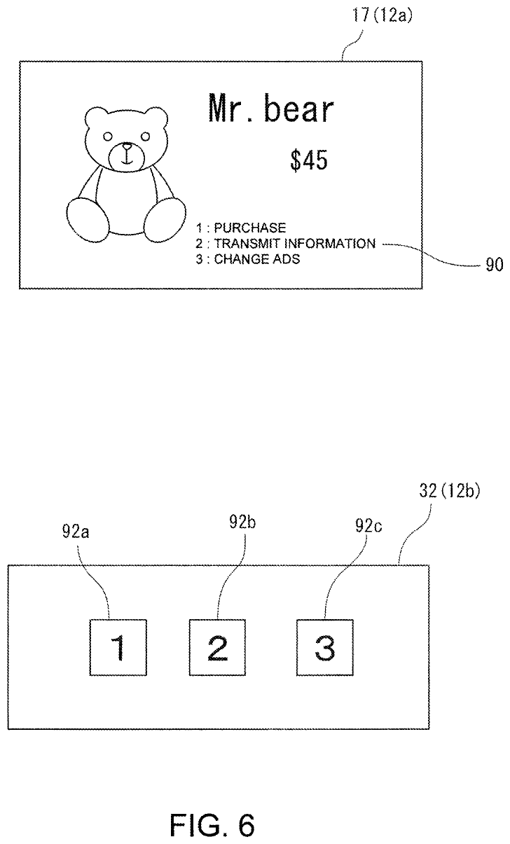

The occupant of the viewer vehicle 12b who is viewing the image displayed on the displayer vehicle 12a operates the user interface 32 as needed to input a predetermined operation instruction, which is explained with reference to FIG. 6. FIG. 6 shows an example image displayed on the display area 17 of the displayer vehicle 12a and an example user interface 32 of the viewer vehicle 12b. It is assumed, as illustrated in FIG. 6, that the display area 17 of the displayer vehicle 12a shows an image for advertising a stuffed bear and selectable options 90 of “1: PURCHASE, 2: TRANSMIT INFORMATION, and 3: CHANGE ADS”.

In this example, the user interface 32 in the viewer vehicle 12b is configured to be capable of responding to a query. For example, when the user interface 32 mounted on the viewer vehicle 12b includes a touch panel, three virtual switches 92a to 92c corresponding to the options of “1”, “2”, and “3” are displayed on the touch panel.

It is also assumed that the occupant of the viewer vehicle 12b operates the user interface 32 and inputs the predetermined operation instruction through the user interface 32. In this case, the operation instruction is transmitted as the action data 88 from the viewer vehicle 12b to the displayer vehicle 12a. The displayer vehicle 12a transmits the received action data 88 to the management center 14. The management center 14 interprets the received action data 88 and performs processing corresponding to the contents of the action data 88. In the example of FIG. 6, when the option “1: PURCHASE” is selected, the management center 14 performs a procedure to purchase a commodity product that is advertised by the corresponding image data 84. Then, the management center 14 uses, as required, information on a credit card of the occupant, for example, that is recorded in the vehicle database 48. Alternatively, when the option “2: TRANSMIT INFORMATION” is selected, the management center 14 transmits to an email address owned by the occupant of the viewer vehicle 12b an URL of a web site which provides detailed information about the commodity product that is advertised. Then, the management center 14 uses, as required, information on the email address of the occupant recorded in the vehicle database 48, for example. Further alternatively, when the option “3: CHANGE ADS” is selected, or when no operation is performed for a predetermined length of time, the management center 14 sends a request for displaying image data 84 of another image to the displayer vehicle 12a.

It should be noted that there may, of course, be cases where the viewer vehicle 12b is not equipped with the user interface 32 which does not have a sufficient function for selecting the options. In such a case, the image of the selectable options is not displayed on the display area 17. Further, the action data 88 is not transmitted from the viewer vehicle 12b to the displayer vehicle 12a.

As described above, when information about the viewer vehicle 12b is acquired as the surrounding information 80 through vehicle-to-vehicle communication, and the image displayed on the displayer vehicle 12a is selected based on the surrounding information 80, it becomes possible to supply the occupant of the viewer vehicle 12b with an image that is suitable for the occupant. Therefore, the present disclosure discloses the signage system which is improved as described above in the effects of posting advertisement and attracting attention.

It should be noted that the above-described components and configurations thereof are presented merely by way of illustration, and may be changed as appropriate as long as the features that information of at least one of the viewer vehicle 12b and the occupant thereof is collected as the surrounding information 80 through communication with viewer vehicle 12b, and that the image displayed on the display area 17 is selected based on the collected surrounding information 80 are at least provided. For example, selection of the image data 84, which is performed in the management center 14 in the above example, may be performed at a vehicle 12. That is, the vehicle controller 50 may have the vehicle database 48 and the image database 46 and select the image data 84 to be displayed on the display area 17 with reference to the databases 46, 48.

Information, such as the attribute information of the vehicle 12, may not necessarily be stored in the management center 14, and may be managed in each vehicle 12. For example, upon receipt of identification information of the viewer vehicle 12b from the displayer vehicle 12a, the management center 14 identifies the viewer vehicle 12b based on the received identification information. Then, the management center 14 may communicate with the identified viewer vehicle 12b to acquire information, such as the attribute information of the viewer vehicle 12b and its occupant.

In addition, the surrounding information 80 may be collected not by the displayer vehicle 12a, but by the management center 14. For example, the center controller 52 may identify a possible vehicle 12 which can function as the viewer vehicle 12b based on a current position of the displayer vehicle 12a, and communicate with the identified vehicle 12 to collect the surrounding information 80. In this case, however, it is necessary for the management center 14 to recognize current positions of a great number of vehicles, which can result in complicated processing. On the other hand, when the displayer vehicle 12a is configured to collect the surrounding information 80 as described above, because the management center 14 does not need to search for vehicles 12 which are present around the displayer vehicle 12a, the processing can be simplified.

Further, while the displayer vehicle 12a encounters a multiplicity of viewer vehicles 12b in the course of driving through various routes, not all of the viewer vehicles 12b may have the capability of vehicle-to-vehicle communication. Then, in consideration of a situation where the viewer vehicle 12b does not have the capability of vehicle-to-vehicle communication, a camera for capturing an image of the license plate and other features of the viewer vehicle 12b may be mounted on the displayer vehicle 12a, and the image data 84 may be selected based on the information obtained from images captured by the camera.

### REFERENCE SIGN LIST

10 signage system; 12 vehicle; 12a displayer vehicle; 12b viewer vehicle; 14 management center; 16 display device; 17 display area; 18 signage controller; 24 information collecting unit; 26 sensor group; 28 display controlling unit; 30 information supplying unit; 40 image selecting unit; 42 display instructing unit; 44 action processing unit; 46 image database; 48 vehicle database; 50 vehicle controller; 52 center controller; 60, 66 processor; 62, 68 storage device; 64, 70 communication interface; 65, 71 data bus; 80 surrounding information; 84 image data; 88 action data; 90 option; 92a-92c virtual switch.

1. A signage system comprising:
at least one vehicle;
a display device mounted on the at least one vehicle and configured to display an image on one or more display areas viewable from outside of the at least one vehicle; and
a signage controller, wherein
the signage controller is configured to function as;
an information collecting unit configured to communicate with a viewer vehicle which is another vehicle located at a position facing the display area, to collect information of at least one of the viewer vehicle and an occupant of the viewer vehicle as surrounding information,
an image selecting unit configured to select, based on the surrounding information, an image to be displayed on the display area, and
a display controlling unit configured to cause the display area to display the selected image.

2. The signage system according to claim 1, wherein
the one or more display areas include at least a display area that is disposed at a position viewable from behind the at least one vehicle.

3. The signage system according to claim 1, wherein
the signage controller is further configured to select the image based on attribute information of at least one of the viewer vehicle and the occupant thereof, the attribute information being found from the surrounding information, and to disable use of action histories of the viewer vehicle and the occupant thereof for selecting the image.

4. The signage system according to claim 1, wherein
the signage controller is further configured to modify the image to be displayed on the display area, based on at least one of a relative positional relationship and a relative velocity relationship between the at least one vehicle and the viewer vehicle.

5. The signage system according to claim 1, wherein
the viewer vehicle comprises a user interface configured to receive an input of an operation instruction directed to the image displayed on the display area of the at least one vehicle, and
the signage controller is configured to perform processing in response to the operation instruction.

6. The signage system according to claim 1, wherein
the signage controller comprises:
a center side controller installed in a management center, and
a vehicle side controller mounted on the at least one vehicle and configured to communicate with the center side controller, wherein the vehicle side controller is further configured to acquire the surrounding information through communication with the viewer vehicle and transmit the acquired surrounding information to the center side controller.
